(19) United States
(12) Patent Application Publication
(10) Pub. No.: US 2024/0141690 A1
(43) Pub. Date: May 2, 2024

(54) LATCHES FOR MOVABLE BARRIERS OR THE LIKE

(71) Applicant: D & D Group Pty Ltd, Frenchs Forest (AU)

(72) Inventor: Scott Anthony Cosby, Narraweena (AU)

(21) Appl. No.: 18/410,331

(22) Filed: Jan. 11, 2024

Related U.S. Application Data
(63) Continuation-in-part of application No. 17/264,366, filed on Jan. 29, 2021, now abandoned.

(30) Foreign Application Priority Data
Aug. 1, 2018 (AU) 2018902793

(51) Int. Cl. E05B 17/06; E05B 9/02

(52) U.S. Cl. CPC E05B 17/06; E05B 9/02; E05C 3/004

(57) ABSTRACT

Disclosed is a latch assembly mountable to a structure including a latch, remote actuating unit, and a guide. The guide is adapted to facilitate installation of the latch assembly. The guide is formed separately to the latch and the remote actuating unit. The guide is mounted with one of the latch or remote actuating unit on installation of the assembly on the structure.

### CROSS REFERENCE TO RELATED APPLICATIONS

The present application is a continuation-in-part of U.S. patent application Ser. No. 17/264,366, filed Jan. 29, 2021, which is a national stage entry of PCT/AU2019/050808, filed Aug. 1, 2019, which claims priority to Australian patent application number AU 2018902793, filed Aug. 1, 2018, the entire contents of which are incorporated herein by reference.

### TECHNICAL FIELD

The present invention relates to a latch assembly mountable to a structure, a method of installing a latch assembly to a structure, and a guide for installation of a latch assembly on a structure.

### BACKGROUND ART

Various forms of latches and, in particular, gravity latches, have been previously proposed such as U.S. Pat. No. 6,058,747 (Doyle et al) U.S. Pat. No. 6,513,351 (Clark) and U.S. Pat. No. 9,476,228 (Karez et al).

U.S. Pat. No. 6,058,747 (Doyle et al) discloses a gravity latch assembly where a remote actuator unit is adapted to be mounted on the opposite or rear face of a gate post so that, subject to any unlocking required of the remote actuator unit, the latching element can be released by the remote actuator unit via a connector to release the striker arm so that the gate may be opened from the rear side. The connector is positioned externally of the gate post to allow ease of installation; however, the connector is exposed to the external environment.

U.S. Pat. No. 6,513,351 (Clark) discloses a gravity latch assembly where a latching element can be released by a remote actuator unit via a connector passing through an aperture provided in a gate post. The connector further allows the latching element to be locked by either the latch or remote actuator unit. Whilst the connector resides in the aperture of the gate post, such arrangement requires the latch to be axially aligned with the remote actuator unit for effortless operation.

U.S. Pat. No. 9,476,228 (Karez et al) also discloses latch assembly where a latching element can be released by a remote actuator unit via a connector passing through an aperture provided in a gate post. The connector further allows the latching element to be locked by either the latch or remote actuator unit. The connector is moved axially when unlatching and rotated about its longitudinal axis when locking and unlocking. Each opposed end of the connector engages with components of the latch and the actuator respectively. Such an arrangement requires the latch and actuator to be axially aligned with the connector so as to reduce the likelihood of concentrating stress on the components of the latch and actuator engaging the opposed ends of the connector.

It is to be understood that, if any prior art is referred to herein, such reference does not constitute an admission that the prior art forms a part of the common general knowledge in the art, in Australia or any other country.

### SUMMARY

The latch assembly and method of installing a latch assembly disclosed herein may simplify the installation of latch assemblies, whilst maintaining the functionality of the latch assemblies.

According to a first aspect, disclosed is a latch assembly mountable to a structure including a latch, remote actuating unit, and a guide formed separate to the latch and the remote actuating unit, the latch and remote actuating unit being arranged to be connected via at least one aperture formed in the structure and wherein the guide is adapted to facilitate installation of the latch assembly, wherein the guide is mounted with one of the latch or remote actuating unit on installation of the assembly on the structure.

In some forms, the guide forms a base plate of the latch or remote actuating unit. Integrating the guide as a part of the latch of the remote actuating unit simplifies mounting of the latch assembly to the structure and reduces the tool required for installation.

In some forms, the guide comprises a body having at least one marking indicator and at least one alignment indicator to facilitate formation of the at least one aperture in the structure. In this way, the guide may be used to easily and efficiently mark the correct position for the at least one aperture in the structure. In some forms, the body further includes a reference axis that in use is arranged to be aligned in a direction of the structure when the guide is facilitating installation of the latch or remote actuating unit. The at least one marking indicator and the at least one alignment indicator may be aligned in a plane that is substantially perpendicular to the reference axis.

According to a second aspect, disclosed is a guide for installation of a latch assembly on a structure, the guide comprising a body having at least one marking indicator and at least one alignment indicator, and the body includes a reference axis, wherein the at least one marking indicator and the at least one alignment indicator are aligned in a plane that is substantially perpendicular to the reference axis. Aligning the at least one marking indicator and the at least one alignment indicator in a plane facilitates mounting of the latch assembly on the structure and it may reduce the margin for human error. The guide remains in position when both the least one marking indicator and the at least one alignment indicator are being made. In use, the reference axis may be arranged to be aligned in a vertical direction of the structure when the guide is facilitating installation of the latch.

In some forms, the reference axis is arranged to be aligned on, or substantially parallel to, an edge of the structure. This visual, and in some embodiments structural, guide further eliminates the possibility of human error when installing the latch assembly on the structure. The reference axis may be defined by at least a portion of an edge of the body.

In some forms, the body includes a main portion and further comprises at least one flange turned from the main portion of the body, the at least one flange includes an inner surface, wherein, in use, the at least one flange is arranged to align the reference axis of the body relative to the structure by the inner surface abutting against the structure. The at least one flange may extend substantially perpendicular from the main portion of the body such that, in use, the reference axis is aligned with one or more interior corners formed between the at least one flange and the main portion of the body. In alternative embodiments, there may be two flanges positioned at an angle relative to the body. In alternative embodiments, there may be one flange that extends the length of the main body portion. It is understood that any number or shape of flange may be suitable.

In some forms, the at least one alignment indicator is positioned on an edge of the body. In some forms, the edge is formed on the main portion of the body.

In some forms, the at least one marking indicator is defined by a pre-formed hole formed in the body. The body may include at least one aperture to receive a connector of the latch assembly therethrough. In one embodiment, the at least one pre-formed hole is concentric with the at least one aperture. In some forms, the guide further comprises a frangible portion including the at least one pre-formed hole that overlays the at least one aperture and is removable from the body. Advantageously, the frangible portion may include at least one snap tab or a reduced section to enable the member to be easily removed.

In one embodiment, the at least one pre-formed hole is spaced from the at least one aperture. In some forms, the body comprises two apertures and each aperture is spaced equidistance from a central axis, such that when the body is rotated substantially about 180°, the position of the two apertures is in a mirrored orientation.

In some forms, the body comprises two apertures and each aperture is spaced equidistant from the pre-formed hole. When the body is rotated substantially about 180°, the position of the two apertures may be in a mirrored orientation.

In some forms, the at least one aperture may be provided on a first face of the main portion of the body and the at least one alignment indicator may be provided on a second face of the main portion of the body. In some forms, the first face is substantially perpendicular to the second face.

The guide may further comprise at least one flange extending substantially perpendicular from at least one side of the body. Preferably, the at least one flange extends substantially perpendicular from the first face of the body.

In some embodiments, the body comprises a second marking indicator, and the second marking indicator is spaced from the first marking indicator.

In some forms, the at least one alignment indicator may be an indentation, recess or protrusion.

In some embodiments, the at least one marking indicator may be a through hole.

In one embodiment, the main portion of the body and the at least one flange comprises a series of apertures for receiving fastening means.

According to a third aspect, disclosed is a latch assembly according to the first aspect or the second aspect further comprising a connector for connecting the latch to the remote actuating unit. In some forms, the connector is adapted to be inserted into the latch and co-operable with the remote actuating unit via the at least one aperture.

According to a fourth aspect, disclosed is a method of installing a latch assembly for a structure, the latch assembly comprising a latch, remote actuating unit, and a guide formed separate to the latch and the remote actuating unit, the method comprising:
positioning a guide on the structure, wherein the guide is adapted to facilitate installation of the latch assembly;
mounting the latch or remote actuating unit to the guide on installation of the assembly on the structure.

In some forms, the method further comprises interconnecting the latch and the remote actuating unit via a connector which extends through an aperture formed in the guide.

In some forms, the method further comprises aligning apertures to be formed in opposing faces of the structure via the guide, wherein the aligned apertures are positioned along a common axis, wherein the apertures receive the connector.

According to a fifth aspect, disclosed is a method of installing a latch assembly to a structure, the latch assembly comprising a latch, remote actuating unit, and a guide formed separate to the latch and the remote actuating unit, the method comprising:
positioning a guide on the structure, the guide defining a reference plane adapted to facilitate installation of the latch assembly;
forming first and second apertures on opposite sides of the structure, wherein the aligned apertures are positioned along a common axis, the apertures being arranged to be aligned on the reference plane defined by the guide device.

In some forms, the guide comprises a body having at least one marking indicator and at least one alignment indicator, and the body includes a reference axis, wherein the at least one marking indicator and the at least one alignment indicator are aligned in a plane that is substantially perpendicular to the reference axis and defines the reference plane for installation of the latch assembly.

In some forms, the method further comprises aligning the reference axis of the guide to an edge of the structure.

In some forms, the method further comprises marking a first face of the structure using the at least one marking indicator and forming the first aperture at or proximal to the mark.

In some forms, the method further comprises marking a second face of the structure using the at least one alignment indicator.

In some forms, the method further comprises aligning the guide on a third surface using the alignment mark, wherein the third face is arranged to oppose the first face.

In some forms, the method further comprises marking the third face of the structure using the at least one marking indicator and forming the second aperture at or proximal to the mark on the third face, wherein the first aperture and the second aperture are aligned in the reference plane and along the common axis to receive a connector.

In some forms, the method further comprises connecting the connector to the latch and the remote actuating unit via the aligned apertures.

In some forms, the body includes a main portion and further comprising at least one flange turned from the main portion of the body, the at least one flange including an inner surface, and the method further comprising positioning the reference axis relative to the structure by abutting the inner surface of against the structure.

In some forms, the at least one flange extends substantially perpendicular from the main portion of the body and the method further comprises defining the reference axis with one or more interior corners formed between the at least one flange and the main portion of the body.

According to a sixth aspect, a guide for installation of a latch assembly on a structure, the latch assembly comprising a latch, remote actuating unit, and the guide is formed separate to the latch and the remote actuating unit, the guide is adapted to facilitate installation of the latch assembly, wherein, when the latch assembly is installed on the structure, the guide is integrated as a part of the latch or the remote actuating unit.

In some forms, the guide forms a base plate of the latch or remote actuating unit.

In some forms, disclosed is a guide according to the sixth aspect, which is otherwise as defined in the second aspect.

According to a seventh aspect, disclosed is a method of installing a latch assembly to a structure wherein the latch assembly comprises a latch and a remote actuator unit, said latch is adapted to co-operate with a striker arm, the method comprising the following steps:
a. mounting a guide to a front face of the structure, the guide comprising a body having two apertures, at least one marking indicator and at least one alignment indicator, and the body includes a reference axis, wherein the at least one marking indicator and the at least one alignment indicator are aligned in a plane that is substantially perpendicular to the reference axis.
b. marking the marking indicator on the front face of the structure;
c. marking the one alignment indicator on a side face of the structure, and extending the marking along the side face perpendicular to the front face;
d. mounting said guide to a rear face of the structure and aligning the alignment indicator with the marking on the side face and marking the one marking indicator on the rear face of the movable barrier or a post;
e. removing the guide;
f. drilling a first hole through the first marking on the front face of the movable barrier or a post
g. drilling a second hole through the second marking on the rear face of the movable barrier or a post, such that the holes are substantially aligned and connected;
h. securing the remote actuator unit to an opposite side the structure to the latch,
i. securing the latch to the front face of the movable barrier or post via the guide;
   wherein the latch is operably connected to the remote actuator unit via a connector through the holes.

In one embodiment, the body includes a frangible portion and the frangible portion includes the marking indicator, whereby the frangible portion may be removable. In some forms, the marking indicator and the aperture are concentric. In some forms, the marking indicator and the aperture reside on a common axis. In some forms, the through holes are substantially concentric with the at least one marking indicator.

In another embodiment, the body may comprise at least two apertures, and each aperture is positioned equidistance or symmetrically from the at least one marking indicator. In some forms, the at least two apertures are positioned in the body in the same plane. In some forms, the at least one marking indicator is positioned on a central axis of the body, such that when the body is rotated substantially about 180°, the position of the at least two apertures may be in a mirrored orientation.

According to a ninth aspect, disclosed is a method of installing a latch assembly to a structure wherein the latch assembly comprises a latch and a remote actuator unit, said latch is adapted to co-operate with a striker arm, the method comprising the following step:
a. mounting a guide to the structure, in which the guide comprises a body having at least one aperture, the body includes a frangible portion that overlays each aperture and the frangible portion includes a marking indicator, wherein the frangible portion is removable from the body;
b. providing a through hole through the marking indicator and the structure;
c. securing the remote actuator unit to an opposite side the structure to the latch,
d. securing the latch to the structure via the guide;
   wherein the frangible is removable from the body to allow the latch to be operably connected to the remote actuator unit.

According to a tenth aspect, disclosed is a connector for operably connecting a latch subassembly to a remote actuator unit, whereby said connector comprises a ball connector at one end. In some forms, the connector comprises a sectional profile (e.g., a non-circular profile) that provides rotational drive. In some forms, the connector comprises a series of linear line measurements, for example a metric measurement on one face and an imperial measurement on the other face. In some forms, the series of linear line measurement may start from the ball connector.

In some embodiments, the latch assembly may be of the type including a displaceable latching element (usually called a tongue) having a latching shoulder to engage with a striker arm with respect to which it is relatively moveable, the tongue having a striker surface adapted to engage with the striker arm to displace the tongue to permit engagement of the striker arm behind the latching shoulder. Typically, but not always, the biasing of the tongue will be under gravity, for example through a pivotal mounting and there is an arrangement to permit the tongue to be displaced to release the striker arm whereby a gate or door is then released to be moved relative to a gate post or door post.

According to another aspect, which is combinable with any other aspect, a gate latch assembly is mountable to a gate or post, and the latch assembly includes a latch, a remote actuating unit, and a guide formed separate to the latch and separate to the remote actuating unit. The latch and the remote actuating unit are configured to be connected via at least one opening aligned along a common axis formed in the gate or post and the guide is configured to facilitate installation of the latch assembly. The guide includes a body adapted for affixing to the gate or post, and the guide body includes two apertures formed therein one of which is configured to align with the common axis when the body is affixed to the gate or post. The guide body also includes two installation markers associated with the two apertures. The remote actuating unit is adapted for affixing to the gate or post which comprises an installation marker where the installation marker of the remote actuating unit is aligned with said one of the installation markers of the guide body when the latch and remote actuator are aligned with the common axis. The guide is configured to be mounted between the gate or post and the latch such that the guide such facilitates installing the latch and remote actuating unit aligned with the common axis.

According to another aspect, which is combinable with any preceding aspect, a method of installing a gate latch assembly to a gate or post including a latch, remote actuating unit, and a guide formed separate to the latch and the remote actuating unit, that are aligned along a common axis, includes: positioning the guide on the gate or post, where the guide comprises a body having two installation markers positioned on a side edge of the body that are visible from a side of the gate or post when installed, and the body has two apertures that are each coplanar with the respective installation marker, forming an opening through the gate or post, the opening being co-axial with one of said apertures in the body and the opening being aligned along the common axis; mounting the latch to the guide on installation of the assembly on the gate or post, such that the guide forms a base plate of the latch, positioning the remote actuator on the gate or post such that the remote actuator overlies a side of the gate or post and has one installation marker positioned that is visible from a side of the gate or post when installed, aligning the installation marker on the remote actuator to the installation marker on the guide that is coplanar with the with the aperture that is coaxial with the common axis, and mounting the remote actuator to the gate or post.

### BRIEF DESCRIPTION OF THE DRAWINGS

There now follows, by way of example only, a detailed description of embodiments of the present disclosure, with reference to the Figures identified below.

FIG. 1 is an isometric view of an embodiment of a guide for a latch assembly;

FIG. 2 is an isometric view of the guide of FIG. 1 mounted to a face of an embodiment of a structure;

FIG. 3 is an isometric view of the guide of FIG. 1 mounted to the structure;

FIG. 4 is an isometric view of the guide of FIG. 1 mounted to an opposite face of the structure;

FIG. 5 is an isometric view of the structure showing an embodiment of a mark on the face of the structure;

FIG. 6 is an isometric view of the structure showing an embodiment of a mark on the opposite face of the structure;

FIG. 7a is an isometric exploded view of the guide of FIG. 1 and an embodiment of a latch.

FIG. 7b is an isometric view of the guide mounted to the latch of FIG. 7a to form a latch subassembly.

FIG. 8a is a side view of an embodiment of a connector and the structure;

FIG. 8b is a side view of the connector of FIG. 8a cut to length and the structure;

FIG. 9a is an isometric view of an embodiment of a remote actuator unit and the connector of FIG. 8b;

FIG. 9b is an isometric view of the connector connected to the remote actuator unit; of FIG. 9a

FIG. 9c is a side view of the connector connected to the remote actuator unit of FIG. 9a;

FIG. 10a is a side view of the latch assembly aligned to be mounted to the structure;

FIG. 10b is a side view of the latch assembly aligned to be mounted to the structure;

FIG. 11 is a side view of the latch assembly mounted to the structure;

FIG. 12a is an isometric view of the latch assembly mounted to a face of the structure;

FIG. 12b is an isometric view of the latch assembly mounted to an opposite face of the structure to FIG. 12a;

FIG. 12c is an isometric view of a further embodiment of the latch assembly mounted to the structure;

FIG. 12d is an isometric view of another embodiment of the latch assembly mounted to the structure;

FIG. 12e is an isometric view of the guide of FIGS. 12c and 12d;

FIG. 13a is a side view of the connector connected to the remote actuator unit mounted to the structure according to the embodiment of FIG. 12d;

FIG. 13b is a side view of the connector connected to the remote actuator unit according to FIG. 13a, whereby the connector is cut to length and mounted to the structure;

FIG. 13c is a latch assembly aligned to be mounted to the structure according to FIG. 13a;

FIG. 13d is a side view of the latch assembly mounted to the structure according to FIG. 13c.

FIG. 14 is an isometric view of a further embodiment of a guide for a latch;

FIG. 15a is a side view of an embodiment of a connector;

FIG. 15b is a side view of the connector of FIG. 15a and an embodiment of a remote actuator unit;

FIG. 16 is a side view of an embodiment of a latch assembly mounted to a structure;

FIG. 17a is a front view of an embodiment of an electronic interface to be used in combination with an embodiment of a latch assembly;

FIG. 17b is a front view of an embodiment of an electronic interface to be used in combination with an embodiment of a latch assembly

FIG. 17c is a front view of an embodiment of an electro-mechanical interface to be used in combination with an embodiment of a latch assembly; and

FIG. 17d is a front view of an embodiment of an electro-mechanical interface to be used in combination with an embodiment of a latch assembly.

### DETAILED DESCRIPTION OF THE EMBODIMENTS

In the following description, functionally similar parts carry the same reference numerals between different embodiments. The drawings are intended to be schematic, and dimensions, scale and/or angles may not be determined accurately from them unless otherwise stated.

It is understood that, unless otherwise stated, the upward and downward directions refer to the orientation of a latch when mounted onto a substantially vertical surface.

It is understood that, unless otherwise stated, the structure may include a moveable barrier, a gate, a fence, a panel, a post or any other suitable structure for mounting a latch assembly.

It is understood that, unless otherwise stated, the terms bracket, and fixture are intended to have their plain meaning.

It is understood that, unless otherwise stated, the term mount includes temporally secured, attached, removably fixed and secured, whereby the term is intended to describe one component placed onto another component or body and not limited to the type of fixture used or if the fixture is permanent or temporary.

It is understood that, unless otherwise stated, the term movable barrier includes, for example, a structure, hatch, gate, door, skylight or window, i.e. a member suitable for closing or opening an aperture, but not limited to the pivotal or direction of movement. For example, the member may pivot or slides horizontally and/or vertically.

It is understood that, unless otherwise stated, the terms aligned and/or alignment are not limited to concentric alignment, horizontal alignment, vertical alignment and planar alignment etc.

Although the following detailed description discloses the latch being mounted on a structure in the form of a post and the striker being mounted on a structure in the form of a gate, in alternative embodiments this may be reversed, i.e. the latch may be mounted on the gate and the striker may be mounted on the post.

It is understood that, unless otherwise stated, the terms contactless device includes for example RFID cards, RFID key fobs, smart phones, smart devices and computers etc.

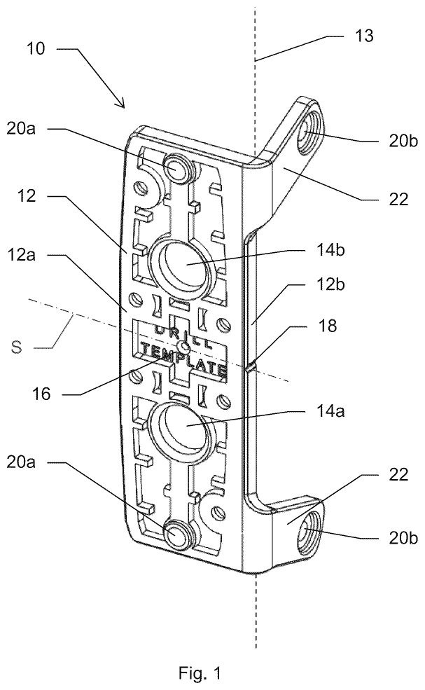

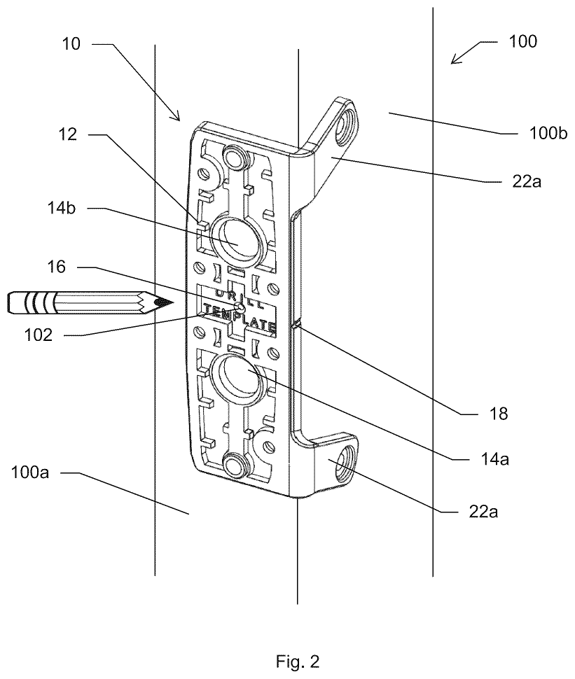

FIG. 1 is an isometric view of a guide 10 for a latch 200 according to a first embodiment. FIGS. 2 to 10 are perspective or side views of a latch assembly mountable to a gate or post including said latch and a remote actuating unit according to the first embodiment.

Referring to FIG. 1, the guide 10 comprises a body 12 having two apertures 14a, 14b, at least marking indicator 16 and an alignment indicator 18. The two apertures 14a, 14b are for receiving a connector 400 of the latch assembly 500 therethrough, which will be described in more detail below. The body 12 further includes a reference axis 13 that in use is arranged to be aligned in a direction of the gate or post when the guide 10 is facilitating installation of the latch assembly. The alignment indicator 18 and the marking indicator 16 may be aligned in a plane that is substantially perpendicular to the reference axis. The reference axis 13 may be defined by at least a portion of an edge of the body 12. As shown, the alignment indicator 18 and the marking indicator 16 reside on a symmetry axis S.

Depending on the orientation of the latch 200 during installation process, i.e. on a left or right pivoting gate, one of the two apertures 14a, 14b is only required to allow a latch 200 to be operably connected to a remote actuator unit 300. Details of the installation of the latch 100 will be described in more detail below. However, it can be envisaged that the two apertures 14a, 14b are provided to give the user an option on their preference for a left or right pivoting gate.

As shown, the two apertures 14a, 14b are positioned on a main portion 12a of the body 12 and the alignment indicator 18 is positioned on an edge 12b of the body 12, wherein the edge is formed on the main portion of the body 12. Each aperture 14a, 14b is spaced from the marking indicator, and in the illustrated embodiment each aperture 14a, 14b is positioned equidistant or symmetrically from the marking indicator 16. In the illustrated embodiment, the two apertures 14a, 14b are positioned on the same vertical plane.

As shown, the marking indicator 16 is positioned on the main portion 12a of the body 12. In the illustrated embodiment, the marking indicator 16 is positioned on a central longitudinal axis of the body 12, such that when the body is rotated substantially about 180°, the position of the two apertures 14a, 14b can be in a mirrored orientation.

As shown in FIG. 1, the guide 10 further comprises at least one flange 22 turned from the main portion 12a of the body 12, wherein the at least one flange 22 includes an inner surface and in use arranged to align the reference axis 13 of the body 12 relative to the post 100 by the inner surface abutting against the post. In the illustrated embodiment, the guide 10 comprises two flanges extending substantially perpendicular from the main portion 12a of the body 12 such that, in use, the reference axis 13 is aligned with one or more interior corners formed between the at least one flange 22 and the main portion 12a of the body 12. The main portion 12a and the flanges 22 comprise apertures 20a, 20b respectively to allow the latch 100 to be secured to the gate or post via the guide 10 using suitable fastening means such mechanical fasteners including screws, bolts, rivets etc. Details of the installation of the latch 200 will be described in more detail below.

FIGS. 2 to 13d show the method steps of the installing the guide 10 which would be used a guide for making the making at least one aperture 106, 108 in a post 100 for the installing the latch 200 and the remote actuator unit 300.

As shown in FIG. 2, the guide 10 is mounted to a corner of a post 100, whereby the body 12 abuts a front face 100a of the post 100 and the two flanges 22 abut a side face 100b of the post 100. As shown, the marking indicator 16 is a pre-formed hole in the body 12 that allows a position mark 102 to be made on the front face 100a of the post 100. Suitable means such as a pen, pencil or centre punch etc. may be used to make the position mark 102. Advantageously, if the post 100 were made from a soft material, such as wood or PVC etc., a nail may be used temporary secure the guide 10 to the post 100 via the marking indicator 16.

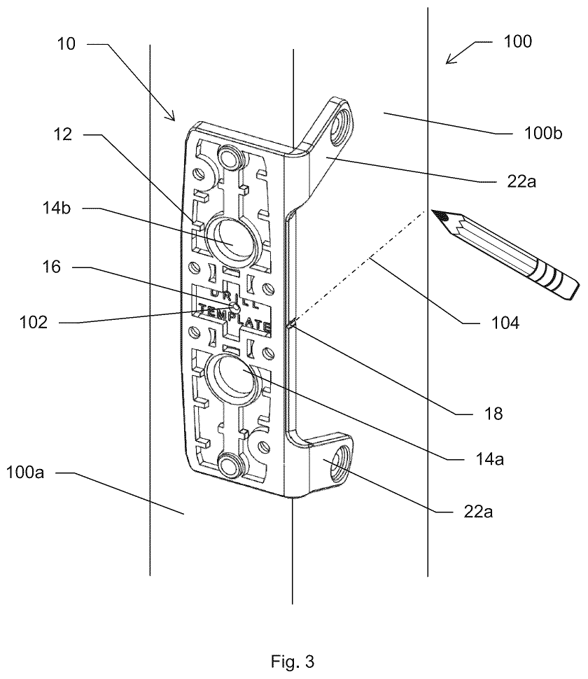

Referring to FIG. 3, a temporary line 104 is drawn, which extends from the alignment indicator 18 and across the side face 100b, whereby the line 104 is substantially perpendicular to the front face 100a. A measuring square or carpenter's square may be used to ensure the line 104 is substantially perpendicular to the front face 100a.

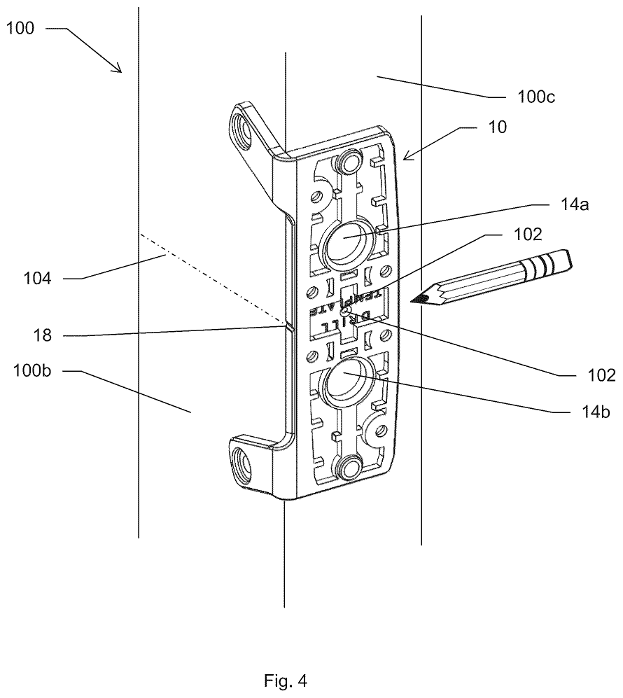

As shown in FIG. 4, the guide 10 is inverted and mounted to a rear corner of the post 100, whereby the body 12 abuts the rear face 100c of the post 100 and the two flanges 22 abut the side face 100b of the post 100. As shown, with the alignment indicator 18 substantially aligned with the line 104, a second position mark 102 to be made on the rear face 100c of the post 100, such that the position marks 102 on the front and rear faces 100a, 100c reside substantially on a common axis. The combination of the position marks 102 and the line 104 allows the first and second apertures 106, 108 to reside substantially on a common axis.

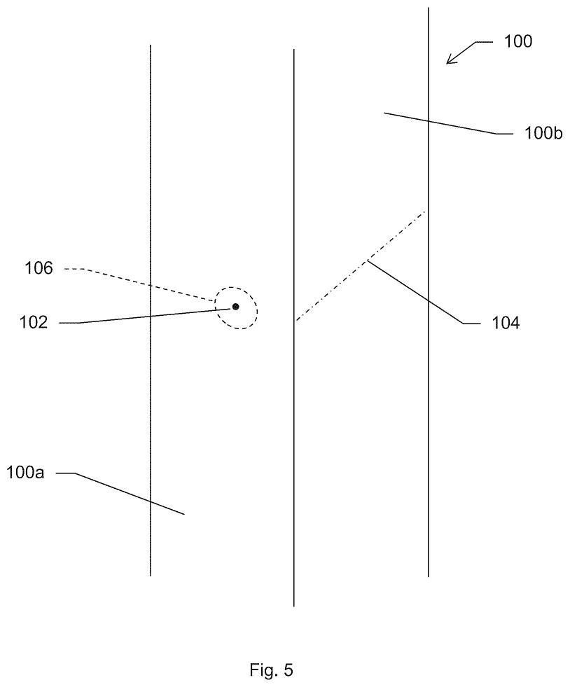

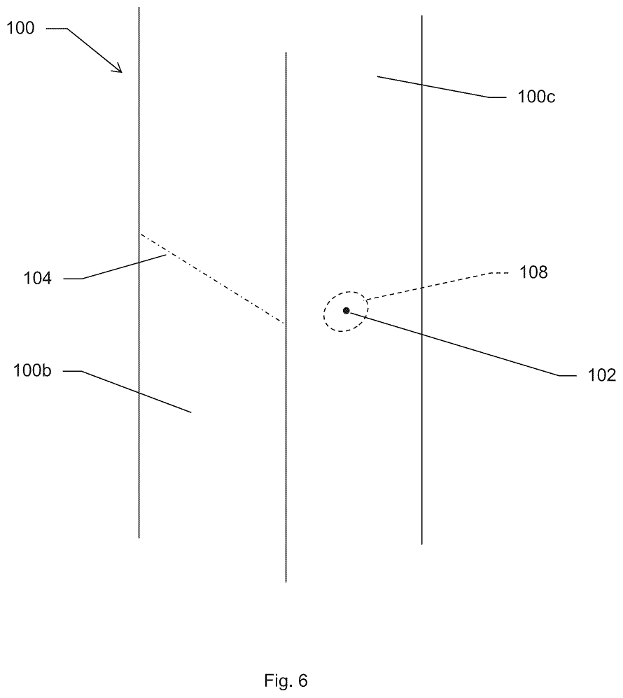

As shown in FIGS. 5 and 6, the guide 10 is removed showing the position marks 102 on the front and rear faces 100a, 100c of the post 100. A first aperture 106 is drilled through the position mark 102 on the front face 100a of the post 100. A second aperture 108 is drilled through the position mark 102 on the rear face 100c of the post 100. The combination of the position marks 102 and the line 104 may be used as a datum or reference point for improving precision of the installation by allowing the first and second apertures 106, 108 to reside substantially on the common axis which extends horizontally through the post.

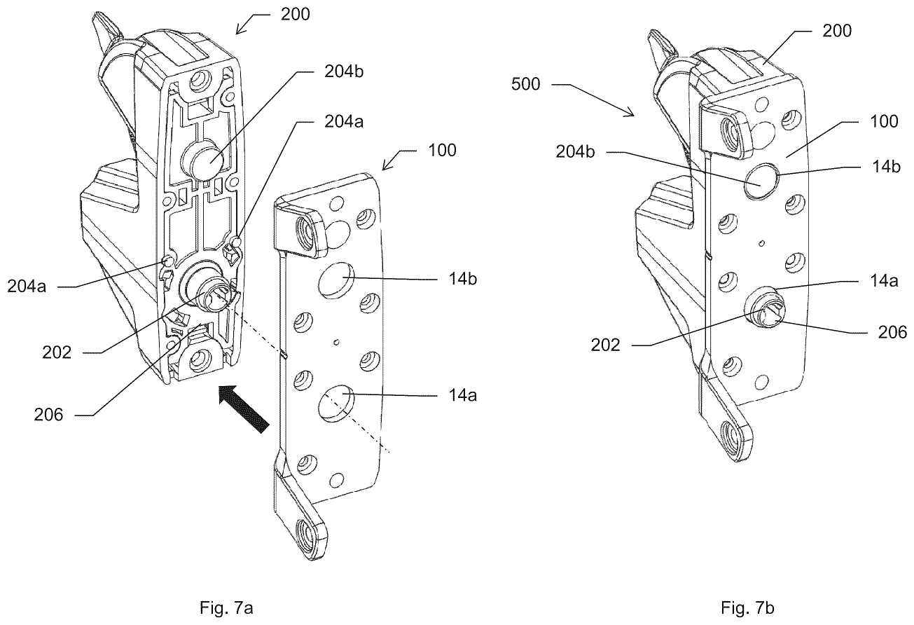

Once the first and second apertures 106, 108 are drilled into the post 100, the guide 10 is mounted with one of the latch or the remote actuating unit to install the assembly on the post 100. In the illustrated embodiment, the guide 10 is removed and mounted to the rear of the latch 200. As shown in FIGS. 7a and 7b, the guide 10 is mounted to the rear of the latch 200 in the form of a base plate to assemble a latch subassembly 500. Advantageously, integrating the guide as a base plate with the latch eliminates the need for an additional tool for installation of the latch assembly, and minimises human measuring error.

The rear of the latch 100 houses a connector portion 202 that is substantially concentric with the first aperture 14a. As shown in FIG. 7b, the connector portion 202 protrudes through the guide 10, which will be described in more detail below. Advantageously, the rear of the latch 200 may be provided with locations means 204a, 204b to mutually engage with corresponding mutually engaging means provided on guide 10 to ensure correct fitment/alignment. As shown in FIG. 7a, the location means 204b is concentric with the second aperture 14b.

Advantageously, suitable fastening means may be used for securing the guide 10 to the rear of the latch 200, such as screws, snap fits and friction fittings etc.

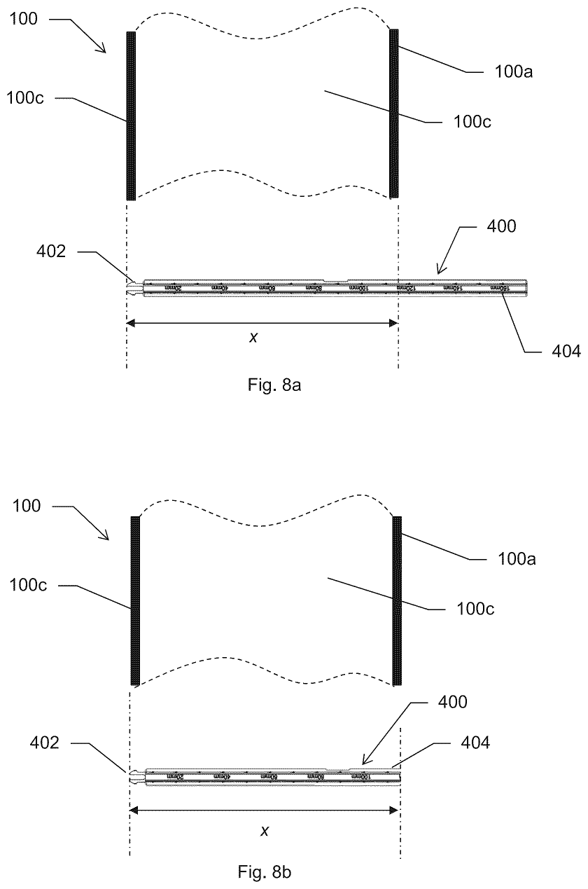

Once the guide 10 is mounted to the rear of the latch 200, the user would cut a connector 400 to size. As shown in FIGS. 8a and 8b, the connector 400 comprises a ball connector 402 at one end and a series of linear line measurements 404, for example a metric measurement on one face and an imperial measurement on the other face, whereby the series of linear line measurement 404 may start from the ball connector 402. The user would measure the depth x of the post 100 and cut the length of the connector 400 to length x.

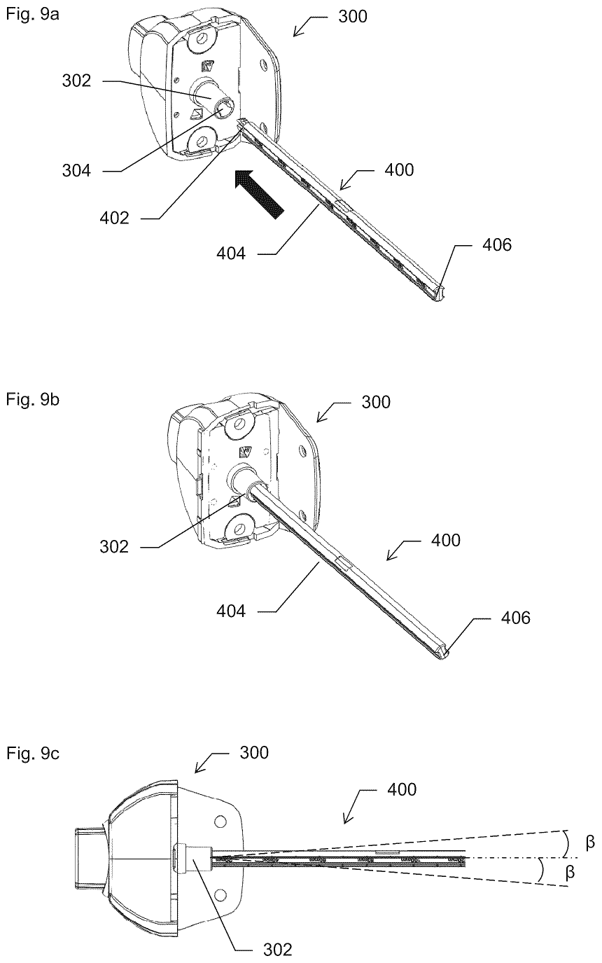

Once the connector 400 is cut to size, the connector 400 is connected to a female connector portion 302 of the remote actuator unit 300 via the connector 402 as shown in FIGS. 9a and 9b. Advantageously, the connector portion 402 snap fits into the female connector portion 302. As shown in FIG. 9c, the connector portion 402 may comprise a ball joint that allows the connector 400 to be pivotally connected to the female connector portion 302 to tilt or to accommodate any misalignment or deviation between the two apertures 106, 108, which will be described in more detail below.

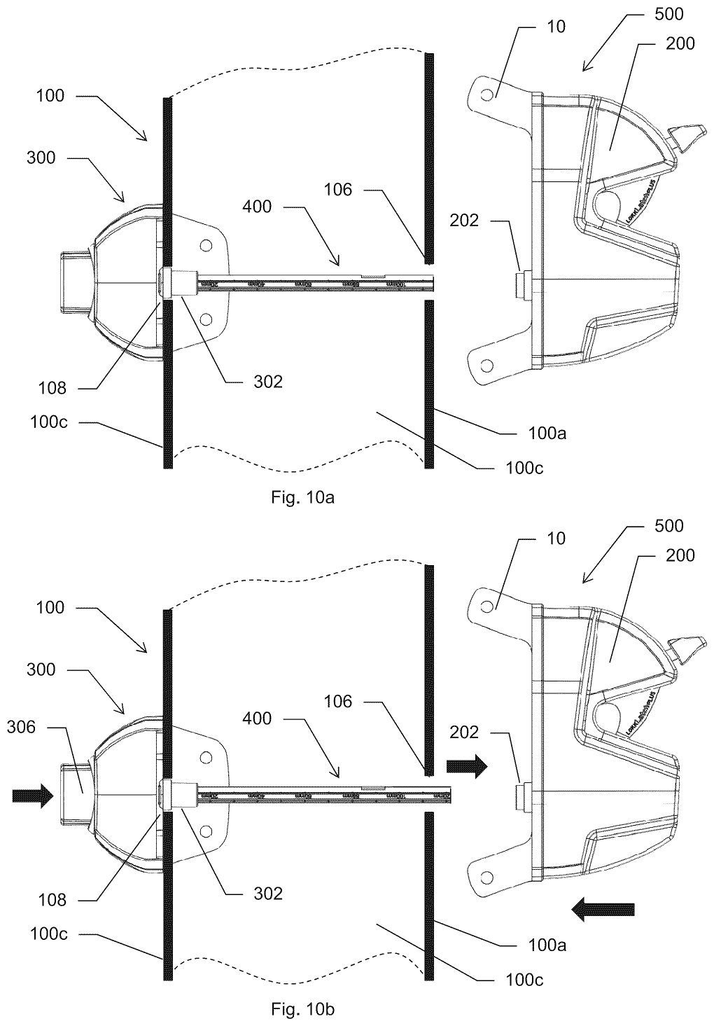

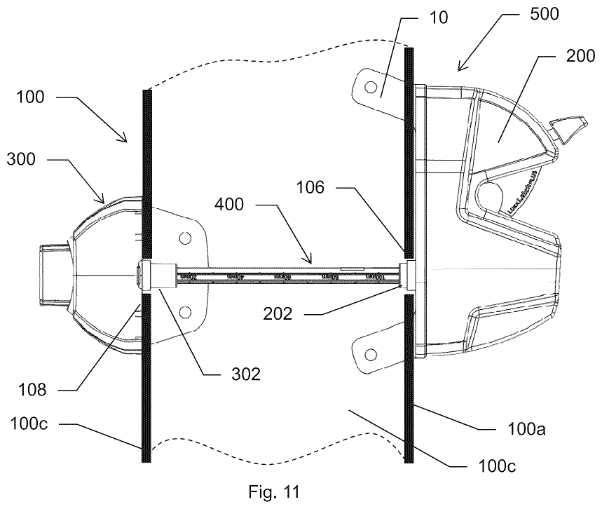

As shown in FIG. 10a, once the connector 400 is connected to the remote actuator unit 300, the remote actuator unit 300 is mounted to the rear face 100c of the post 100. As shown, the connector 400 passes through both apertures 106, 108 whereby the end of the connector 400 and resides in the aperture 108. And, the latch 100 is mounted to the guide 10 to form the latch subassembly 500. As shown in FIG. 10b, a push button 306 on the remote actuator unit 300 is pressed to allow the end of the connector 400 to protrude from the front face 100a to present itself to the connector portion 202 of the latch 200. FIG. 11 shows the latch subassembly 500 and the remote actuator unit 300 mounted to the post 100 and the connector 400 is adapted to be inserted into the latch 200 and co-operable with the remote actuating unit 300 via the apertures 106, 108. As described above, the ball joint 402 allows the connector 400 to be pivotally connected to the female connector portion 302 to accommodate any misalignment or deviation between the two apertures 106, 108, such that the latch 200 and remote actuator unit 300 remain operably connected via the connector 400.

Moreover, as shown in FIGS. 8a to 9b, the connector 400 has a sectional profile 406 that allows that engagement of profiles 206, 304 with respective connector portions 202, 302. This may provide positive axial and/or rotational drive between the remote actuator unit 300 and the latch 200. Advantageously, the remote actuator unit 300 may be used to lock/unlock and unlatch the latch 200.

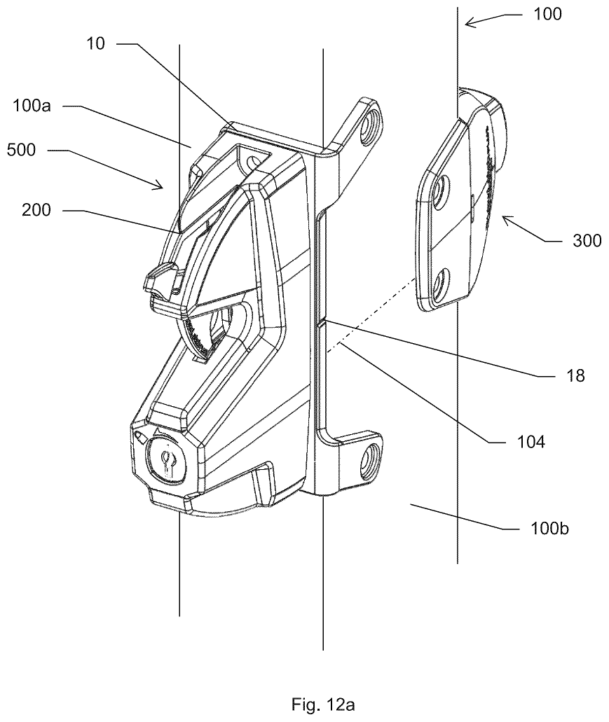

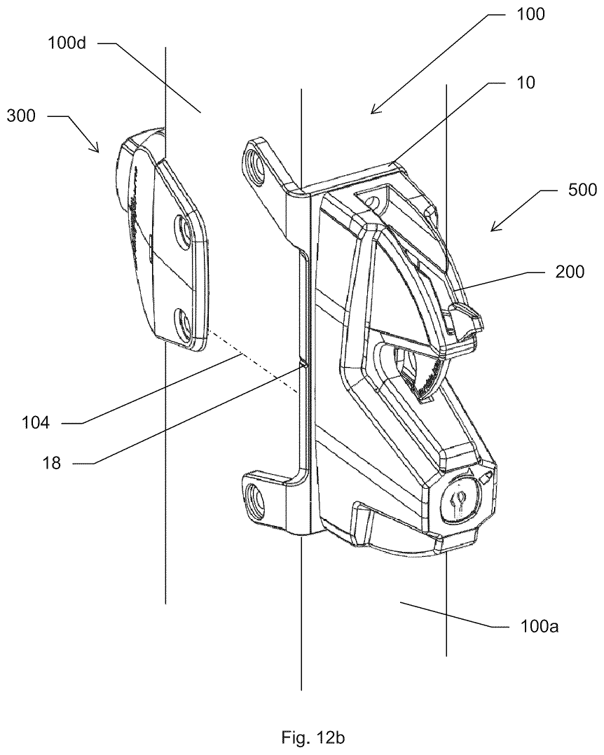

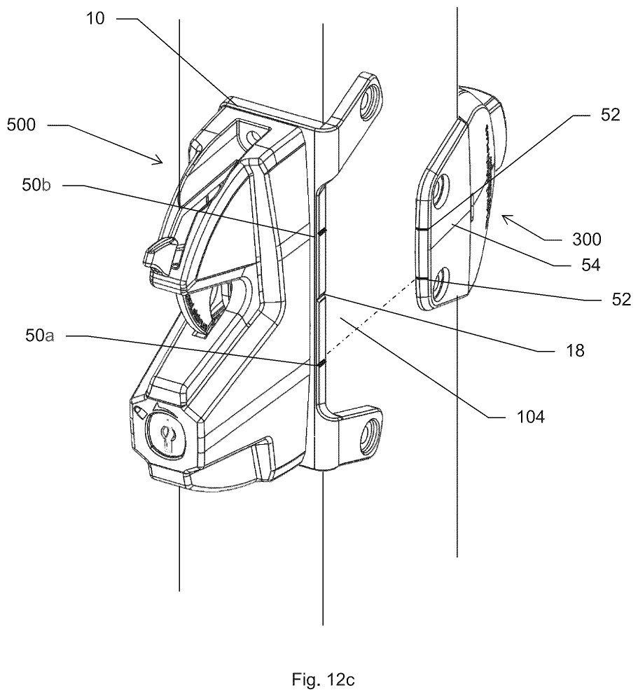

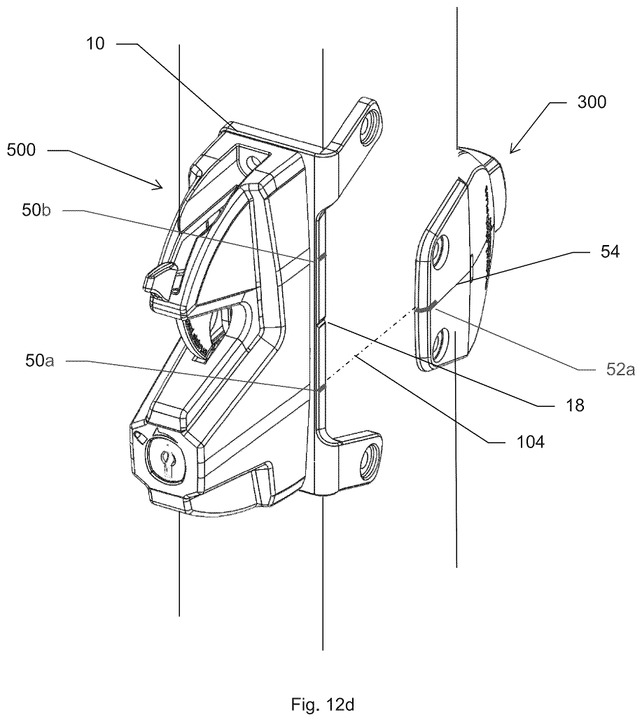

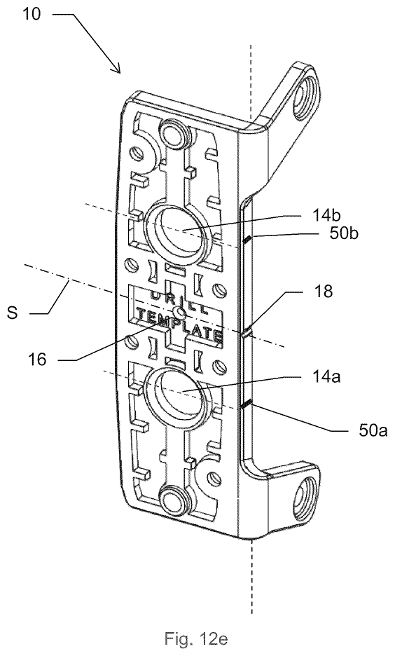

FIG. 12a is an isometric view showing the latch subassembly 500 and the remote actuator unit 300 mounted on the post 100, whereby the latch 200 engages with a striker (not shown) for holding closed a movable barrier or gate (not shown). Once installed, the line 104 can be removed. Alternatively, the latch 200 and the remote actuator unit 300 may be mounted to the movable barrier or gate (not shown) and the striker (not shown) may be mounted to the post 100. As shown, both the guide 10 and the latch 200 is secured to the post 100, whereby the flanges 22 of the installations form the side fixing legs.

As shown in FIG. 12a, once installed the alignment indicator 18 is offset from the line 104. However, the apertures 106, 108 reside substantially on the common axis as shown in FIGS. 10a to 10c to enable the latch subassembly 500 and remote actuator unit to be operably connected via the connector 400.

FIGS. 2 to 12a show the guide 10 is orientated to allow the latch 200 to be installed on the right corner of the post 100, it can also be envisaged the guide 10 can be inverted to allow the latch 200 to be installed on the left corner of the post 100, as shown in FIG. 12b. In such case, the latch assembly 500 can be configured to operate or installed on left or right handed pivoting gates. Such arrangement is achieved by having the two apertures 14a, 14b arranged or positioned equidistance or symmetrically from the marking indicator 16.

As described above, once installed the alignment indicator 18 is offset from the line 104. FIG. 12c shows a further embodiment, whereby a series of installation markers 50, 52 are provided on both the guide 10 and the remote actuator unit 300 to confirm the latch subassembly 500 and the remote actuator unit 300 are correctly installed and aligned with the line 104. As shown in FIG. 12c, two installation markers 50a, 50b are provided on the guide 10 and they are spaced equidistance from the alignment indicator 18. Likewise, two installation markers 52 are provided on the guide 10 and they are spaced equidistance from the centreline 54 of the remote actuator unit 300.

As shown in FIG. 12c, the alignment indicator 18 is a recess, so advantageously the series of installation markers 50a, 50b, 52 may be a protrusion or raised rib to prevent confusion during the installation process. If the alignment indicator 18 were a protrusion or raised rib, the series of installation markers 50, 52 may be a recess. Although the embodiment above discloses two sets of installation markers 50, 52 provided on the guide 10 and the remote actuator unit 300 respectively, it can also be envisaged that only one set of installation markers is required on either the guide 10 or on the rear actuator unit 300.

FIG. 12d shows another embodiment, whereby the series of installation markers 50a, 50b, 52a are provided on both the guide 10 and the remote actuator unit 300 to indicate the latch subassembly 500 and the remote actuator unit 300 are correctly installed and aligned with the line 104. As shown in FIG. 12d, two installation markers 50a, 50b are provided on the guide 10 and they are spaced equidistance from the alignment indicator 18. An installation marker 52a is provided on the rear actuator unit 300.

As shown in FIG. 12d, when the latch subassembly 500 is operably connected to the remote actuator unit 300, the installation marker 52a of the rear actuator unit 300 is aligned with the first installation marker 50a of the latch subassembly 500. It can be envisaged when the latch subassembly 500 is operably connected to the remote actuator unit 300 on an opposite handed installation, the installation marker 52a of the rear actuator unit 300 is aligned with the other (and opposite) installation marker 50b of the latch subassembly 500.

FIG. 12e is an isometric view of the guide 10 of FIGS. 12c and 12d. As shown in FIG. 12e, installation markers 50a, 50b resides on the same plane as their respective apertures 14a, 14b.

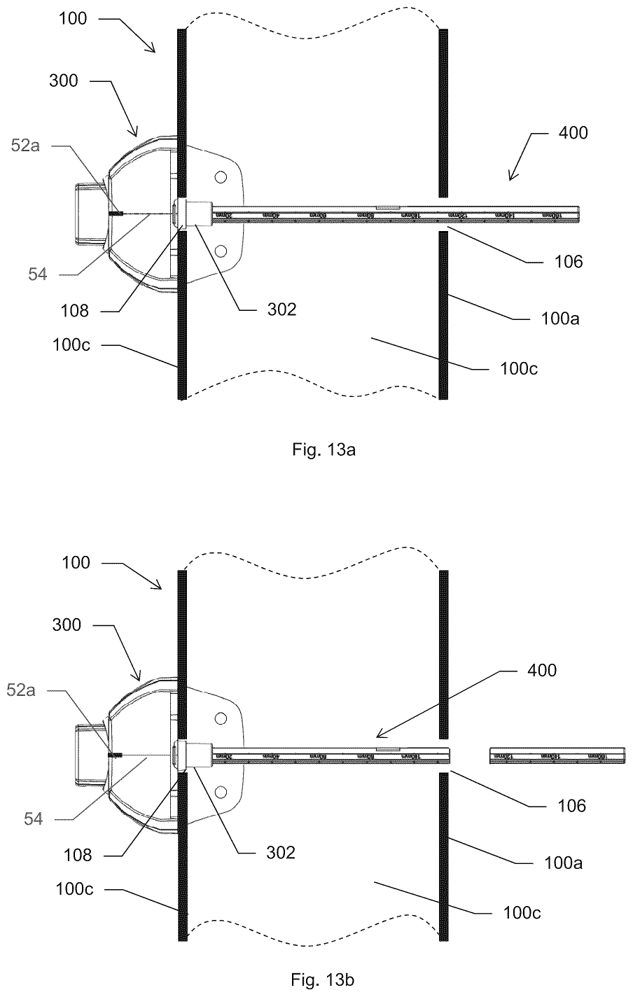

FIGS. 13a to 13d show an alternative method of installing the latch 200 and remote actuator unit 300 to the post 100. As shown in FIG. 13a, the connector 400 is connected to the remote actuator unit 300, wherein the remote actuator unit 300 is mounted to the rear face 100c of the post 100. FIG. 13b shows the connector 400 to size, whereby the end connector 400 would be substantially flush with the front face 100a of the post 100. As shown in FIG. 13c, a push button 306 on the remote actuator unit 300 is pressed to allow the end of the connector 400 to protrude from the front face 100a to present itself to the connector portion 202 of the latch 200. As shown in FIG. 13d, shows the latch subassembly 500 (including the guide 10 in the form of the back plate of the latch 200) and remote actuator unit 300 mounted to the post 100 and are operably connected via the connector 400.

As shown in FIGS. 13a to 13d, the installation marker 52a and the centreline 54 of the remote actuator unit 300 resides on the central axis of the connector 400. In some embodiments, the installation marker 52a is offset to the centreline 54 of the remote actuator unit 300.

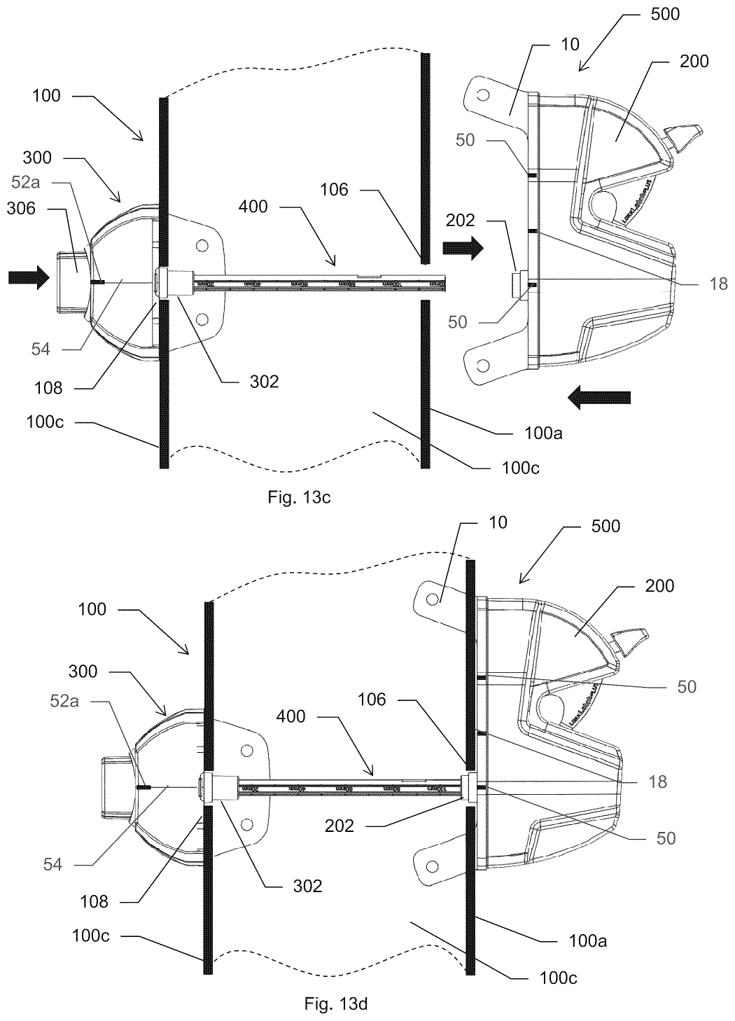

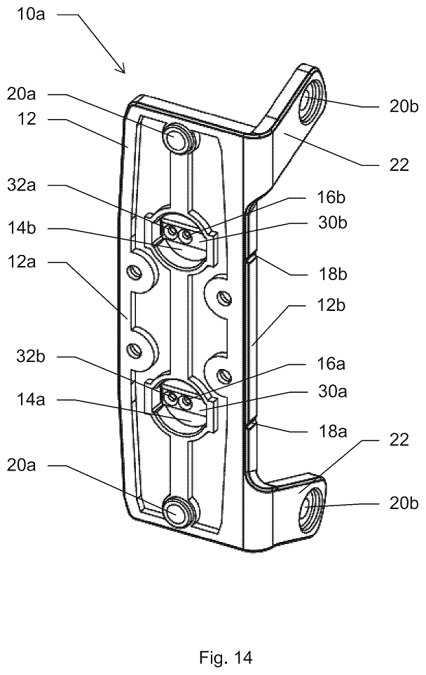

FIG. 14 is an isometric view of a guide according to another embodiment of the present invention, wherein the guide 10 comprises a body 12 having two apertures 14a, 14b, two marking indicator 16a, 16b and two alignment indicators 18a, 18b, wherein each alignment indicator 18a, 18b resides on substantially the same plane as its respective marking indicator 16a, 16b. The guide shown in FIG. 14 may also be mounted with, e.g., form a base plate for, the latch or the remote actuating unit.

As shown, the body 12 includes a frangible portion 30a, 30b overlaying each aperture 14a, 14b that is removable from the main body 12. Each frangible portion 30a, 30b having said marking indicator 16a, 16b, whereby each marking indicator 16a, 16b and its respective aperture 14a, 14b resides on a common axis extending longitudinally along the body.

During installation, the frangible portions 30a, 30b can be removable to allow the latch 100 to be operably connected to the remote actuator unit 200. As described above, depending orientation of the latch assembly 100 during installation process, i.e. on a left or right pivoting gate, one of the two frangible portions 30a, 30b can be removed to allow a latch 200 to be operably connected to the remote actuator unit 300.

As shown, the frangible portions 30a, 30b extend substantially across its respective aperture 14a, 14b. Advantageously, the frangible portions 30a, 30b may be connected to the body by at least one snap tab or reduced section to enable the member 30a, 30b to be easily removed during installation.

In addition, each frangible portion 30a, 30b comprises a second marking indicator 32a, 32b, whereby the second marking indicator 32a, 32b is offset from the first marking indicator 16a, 16b by the thickness of the flange 22. It can be envisaged that the second marking indicator 32a, 32b allows the user the option to rebate the flanges 22 into the gate or post during installation.

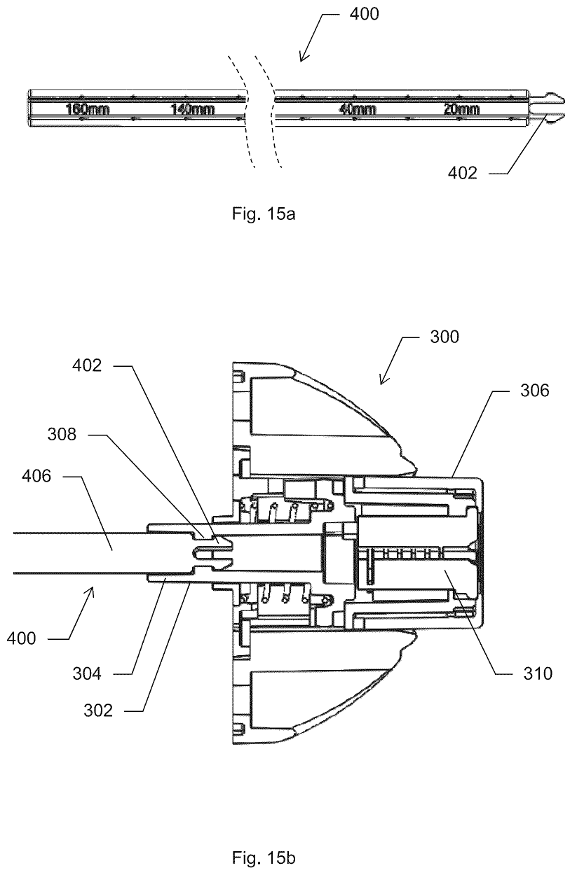

As shown in FIGS. 15a and 15b, the ball connector 402 of the connector 400 snap fits into the female connector portion 302 of the connector 304. A flange 308 is provided in the female connector portion 302 that restricts or prevents the ball connector 402 from being disconnected. The sectional profile 406 of the connector 400 engages with the complementary profile 304 of the connector 304 to provide positive axial and/or rotational drive between the remote actuator unit 300 and the latch 100. In addition, the ball connector 402 allows the connector 400 to be pivotally connected to the female connector portion 302 to tilt or to accommodate any misalignment or deviation between the two apertures 106, 108. As shown in FIG. 15b, the female connector portion 302 is connected to a lock cylinder 310 that is housed in the push button 306, so the push button 306 of the remote actuator unit 300 may be used to lock/unlock and unlatch the latch 200.

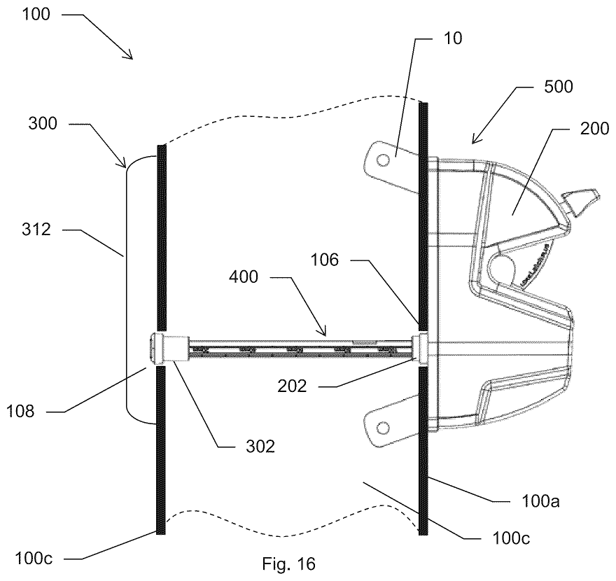

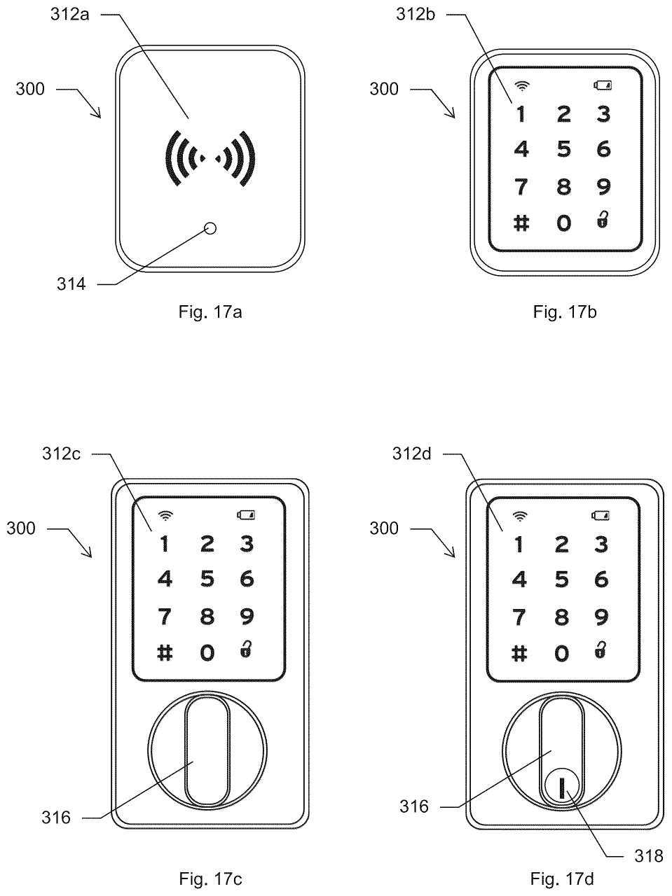

FIGS. 16 to 17b schematically show further embodiments of the present disclosure whereby an electronic or electro-mechanical interface 312, 312a, 312b, 312c and 312d may be used on the remote actuator unit 300 in lieu of the push button 306. As shown in FIG. 16, the connector 400 is connected to a female connector portion 302 of the remote actuator unit 300. FIGS. 17a to 17d show various embodiments of the electronic or electro-mechanical interfaces 312a, 312b, 312c and 312d.

In FIG. 17a, a contactless electronic interface is used whereby wireless, Wi-Fi, RFID, NFC or Bluetooth® communication may be used to lock/unlock and unlatch the latch 200. In this embodiment, at least one status LED 314 is used to provide the status of the remote actuator unit 300, such as low battery warning or confirmation of positive or negative reading of the contactless device etc.

In FIG. 17b, a combination of contactless and PIN electronic interface 312a is used, whereby PIN numbers are granted to third parties or guests for temporary access. In this embodiment, the homeowner would have permanent access, and this can be achieved by using either a unique PIN or a contactless device. The interface 312b comprises at least a numeric keyboard with a series of command buttons. The interface 310b may be a touch screen with status indicators such as battery level or signal strength indicator.

In the embodiments of FIGS. 17a and 17b, the electronic interface 312a, 312b of the remote actuator unit 300 may be used to lock/unlock and unlatch the latch 200 to allow keyless entry with minimal user interaction. In the embodiment of FIG. 17b, a wireless, NFC or Bluetooth® feature of a smart phone may be employed to lock/unlock and unlatch the latch 200.

In the embodiments of FIGS. 17c and 17d, the electronic interface 312c, 312d of the remote actuator unit 300 may be used operate a release mechanism to allow a knob 216 to unlock and/or unlatch the latch 200.

In the embodiments of FIGS. 17a to 17c, the electronic or electro-mechanical interface 312a, 312b and 312c may be powered by batteries and an emergency power supply terminal (not shown) may be provided to ‘jump-start’ the remote actuator unit 300 when the batteries are depleted. In the embodiment of FIG. 17d, the knob 316 may further comprise a lock cylinder that may used to override the electro-mechanical interface 312d when the batteries are depleted.

In the embodiments of FIGS. 16 to 17d, the electronic or electro-mechanical interface 312, 312a, 312b, 312c and 312d may be directly or indirectly wirelessly connected to a LAN.

Applications

Although the embodiments disclose the latch and system being used on gates, it can be envisaged that the latch and system can be used on other applications such as security fencing, zone restriction fencing, doors, safety barriers, security barriers, care homes, garden gates, swimming pool and child care applications etc.

### ALTERNATIVE EMBODIMENTS

Embodiment 1: A latch assembly mountable to a structure including a latch, remote actuating unit, and a guide formed separate to the latch and the remote actuating unit, the latch and remote actuating unit being arranged to be connected via at least one aperture formed in the structure and wherein the guide is adapted to facilitate installation of the latch assembly, wherein the guide is mounted with one of the latch or remote actuating unit on installation of the assembly on the structure.

Embodiment 2: A latch assembly according to Embodiment 1, wherein the guide forms a base plate of the latch or remote actuating unit.

Embodiment 3: A latch assembly according to either embodiment 1 or 2, wherein the guide comprising a body having at least one marking indicator and at least one alignment indicator to facilitate formation of the at least one aperture in the structure.

Embodiment 4: A latch assembly according to embodiment 3, wherein the body further includes a reference axis that in use is arranged to be aligned in a direction of the structure when the guide is facilitating installation of the latch or remote actuating unit.

Embodiment 5: A latch assembly according to embodiment 4, wherein the at least one marking indicator and the at least one alignment indicator are aligned in a plane that is substantially perpendicular to the reference axis.

Embodiment 6: A guide for installation of a latch assembly on a structure, the guide comprising a body having at least one marking indicator and at least one alignment indicator, and the body includes a reference axis, wherein the at least one marking indicator and the at least one alignment indicator are aligned in a plane that is substantially perpendicular to the reference axis.

Embodiment 7: A latch assembly or guide according to any one of embodiments 4 to 6, wherein in use, the reference axis is arranged to be aligned on, or substantially parallel to, an edge of the structure.

Embodiment 8: A latch assembly or guide according to any one of embodiments 4 to 7, wherein the reference axis is defined by at least a portion of an edge of the body.

Embodiment 9: A latch assembly or guide according to any one of embodiments 4 to 8, wherein the body includes a main portion and further comprising at least one flange turned from the main portion of the body, the at least one flange including an inner surface, wherein, in use, the at least one flange is arranged to align the reference axis of the body relative to the structure by the inner surface abutting against the structure.

Embodiment 10: A latch assembly or guide according to embodiment 9, wherein the at least one flange extends substantially perpendicular from the main portion of the body such that, in use, the reference axis is aligned with one or more interior corners formed between the at least one flange and the main portion of the body.

Embodiment 11: A latch assembly or guide according to any one of embodiments 3 to 10, wherein the at least one alignment indicator is positioned on an edge of the body.

Embodiment 12: A latch assembly or guide according to embodiment 11, when dependent on embodiment 9, wherein the edge is formed on the main portion of the body.

Embodiment 13: A latch assembly or guide according to any one of embodiments 3 to 12, wherein the at least one marking indicator is defined by a pre-formed hole formed in the body.

Embodiment 14: A latch assembly or guide according to any one of embodiments 3 to 13, wherein the body includes at least one aperture to receive a connector of the latch assembly therethrough.

Embodiment 15: A latch assembly or guide according to embodiment 14, when dependent on embodiment 13 wherein the at least one pre-formed hole is concentric with the at least one aperture.

Embodiment 16: A latch assembly or guide according to embodiment 15, further comprising a frangible portion including the at least one pre-formed hole that overlays the at least one aperture and is removable from the body.

Embodiment 17: A latch assembly or guide according to any one of embodiment 16, wherein body comprises two apertures and each aperture is spaced equidistance from a central axis, such that when the body is rotated substantially about 180°, the position of the two apertures is in a mirrored orientation.

Embodiment 18: A latch assembly or guide according to embodiment 14, when dependent on embodiment 13, wherein the pre-formed hole is spaced from the at least one aperture.

Embodiment 19: A latch assembly or guide according to embodiment 18, wherein body comprises two apertures and each aperture is spaced equidistance from the pre-formed hole, such that when the body is rotated substantially about 180°, the position of the two apertures is in a mirrored orientation.

Embodiment 20: A latch assembly according to any preceding embodiment further comprising a connector for connecting the latch to the remote actuating unit.

Embodiment 21: A latch assembly according to embodiment 20 wherein the connector is adapted to be inserted into the latch and co-operable with the remote actuating unit via the at least one aperture.

Embodiment 22: A latch assembly according to any preceding embodiment, whereby the remote actuating unit comprises a push button and a locking cylinder for locking/unlocking and/or unlatching the latch.

Embodiment 23: A latch assembly according to any one of embodiments 1 to 21 preceding embodiment, whereby the remote actuating unit comprises an electronic or electro-mechanical interface for locking/unlocking and/or unlatching the latch.

Embodiment 24: A latch assembly according to embodiment 23, wherein the remote actuating unit may be operated via a contactless device.

Embodiment 25: A latch assembly according to embodiment 24, wherein the remote actuating unit may be directly or indirectly wirelessly connected to a LAN.

Embodiment 26: A method of installing a latch assembly for a structure, the latch assembly comprising a latch, remote actuating unit, and a guide formed separate to the latch and the remote actuating unit, the method comprising:
positioning a guide on the structure, wherein the guide is adapted to facilitate installation of the latch assembly;
mounting the latch or remote actuating unit to the guide on installation of the assembly on the structure.

Embodiment 27: A method according to embodiment 26, further comprising interconnecting the latch and the remote actuating unit via a connector which extends through an aperture formed in the guide.

Embodiment 28: A method according to embodiment 27, further comprising aligning apertures to be formed in opposing faces of the structure via the guide, wherein the aligned apertures are positioned along a common axis, wherein the apertures receive the connector.

Embodiment 29: A method of installing a latch assembly for a structure, the latch assembly comprising a latch, remote actuating unit, and a guide formed separate to the latch and the remote actuating unit, the method comprising:
positioning a guide on the structure, the guide defining a reference plane adapted to facilitate installation of the latch assembly;
forming first and second apertures on opposite sides of the structure, wherein the aligned apertures are positioned along a common axis, the apertures being arranged to be aligned on the reference plane defined by the guide device.

Embodiment 30: A method according to embodiment 29, wherein the guide comprises a body having at least one marking indicator and at least one alignment indicator, and the body includes a reference axis, wherein the at least one marking indicator and the at least one alignment indicator are aligned in a plane that is substantially perpendicular to the reference axis and defines the reference plane for installation of the latch assembly.

Embodiment 31: A method according to embodiment 30, further comprising aligning the reference axis of the guide to an edge of the structure.

Embodiment 32: A method according to embodiment 30, further comprising marking a first face of the structure using the at least one marking indicator and forming the first aperture at or proximal to the mark.

Embodiment 33: A method according to embodiment 32, further comprising marking a second face of the structure using the at least one alignment indicator.

Embodiment 34: A method according to embodiment 33, further comprising aligning the guide on a third surface using the alignment mark wherein the third face is arranged to oppose the first face.

Embodiment 35: A method according to embodiment 33, further comprising marking the third face of the structure using the at least one marking indicator, and forming the second aperture at or proximal to the mark on the third face, wherein the first aperture and the second aperture are aligned in the reference plane and along the common axis to receive a connector.

Embodiment 36: A latch assembly according to embodiment 35, further comprising connecting the connector to the latch and the remote actuating unit via the aligned apertures.

Embodiment 37: A method according to any one of embodiments 29 to 36, wherein the body includes a main portion and further comprising at least one flange turned from the main portion of the body, the at least one flange including an inner surface, and the method further comprising positioning the reference axis relative to the structure by abutting the inner surface of against the structure.

Embodiment 38: A method according to embodiment 37, wherein the at least one flange extends substantially perpendicular from the main portion of the body and the method further comprises defining the reference axis with one or more interior corners formed between the at least one flange and the main portion of the body.

Embodiment 39: A guide for installation of a latch assembly on a structure, the latch assembly comprising a latch, remote actuating unit, and the guide is formed separate to the latch and the remote actuating unit, the guide is adapted to facilitate installation of the latch assembly, wherein, when the latch assembly is installed on the structure, the guide is integrated as a part of the latch or the remote actuating unit.

Embodiment 40: A guide according to embodiment 39, wherein the guide forms a base plate of the latch or remote actuating unit.

Embodiment 41: A guide according to embodiment 38, which is otherwise as defined in any one of embodiments 6 to 19.

In the claims which follow and in the preceding disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the present disclosure.

Accordingly, the present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods which can, of course, vary. It is also to be understood that the terminology used herein is for the purpose of describing particular embodiments only, and is not intended to be limiting.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope being indicated by the following claims.

1. A gate latch assembly mountable to a gate or post, the latch assembly including:
a latch, a remote actuating unit, and a guide formed separate to the latch and separate to the remote actuating unit,
the latch and the remote actuating unit being configured to be connected via at least one opening aligned along a common axis formed in the gate or post and wherein the guide is configured to facilitate installation of the latch assembly,
the guide comprising a body adapted for affixing to the gate or post, the guide body having two apertures formed therein one of which is configured to align with the common axis when the body is affixed to the gate or post, the guide body having two installation markers associated with the two apertures,
the remote actuating unit being adapted for affixing to the gate or post which comprises an installation marker, wherein the installation marker of the remote actuating unit is aligned with said one of the installation markers of the guide body when the latch and remote actuator are aligned with the common axis, and
wherein the guide is configured to be mounted between the gate or post and the latch such that the guide such facilitates installing the latch and remote actuating unit aligned with the common axis.

2. A latch assembly according to claim 1, wherein the guide body includes an edge that in use is positioned adjacent an edge of the gate or post, said two installation markers being formed on the edge of the guide body so as to be visible from a side of the gate or post.

3. A latch assembly according to claim 1, wherein guide body is adapted so that each installation marker resides on the same plane as its respective aperture.

4. A latch assembly according to claim 1, wherein the guide body includes a main portion and further comprising at least one flange extending substantially perpendicular from the main portion of the body, the at least one flange including an inner surface, the at least one flange being adapted to facilitate fixing the guide body to a side of the gate or post.

5. A latch assembly according to claim 4, wherein the two apertures are formed in the main portion of the guide body so that they are coplanar.

6. A latch assembly according to claim 5, including a pre-formed hole formed in the guide body and each aperture is spaced equidistance from the pre-formed hole, such that when the body is rotated substantially about 180°, the position of the two apertures is in a mirrored orientation to suite installing on either one of opposed sides of the gate or post.

7. A latch assembly according to claim 6, wherein the pre-formed hole is adapted to accommodate a fixture for fastening the guide to the gate or post.

8. A latch assembly according to claim 6, wherein the pre-formed hole is linearly aligned with both apertures.

9. A latch assembly according to claim 1, wherein the remote actuator overlies an edge of the gate or post so that the installation marker on the remote actuator is visible from the side of the gate or post.

10. A latch assembly according to claim 1, further comprising a connector for connecting the latch to the remote actuating unit.

11. A latch assembly according to claim 10, wherein the connector is adapted to be inserted through said opening in the gate or post extending along the common axis and co-operable between the remote actuating unit and the latch via the at least one aperture of the guide body.

12. A latch assembly according to claim 11 wherein the latch and remote actuator each include connector portions for receiving opposed ends of the connector so as to allow for axial and/or rotation drive between the latch and remote actuator.

13. A method of installing a gate latch assembly to a gate or post comprising a latch, remote actuating unit, and a guide formed separate to the latch and the remote actuating unit, that are aligned along a common axis, the method comprising:
positioning the guide on the gate or post, wherein the guide comprises a body having two installation markers positioned on a side edge of the body that are visible from a side of the gate or post when installed, the body having two apertures that are each coplanar with the respective installation marker,
forming an opening through the gate or post, the opening is co-axial with one of said apertures in the body and the opening is aligned along the common axis;
mounting the latch to the guide on installation of the assembly on the gate or post, such that the guide forms a base plate of the latch,
positioning the remote actuator on the gate or post, wherein the remote actuator overlies a side of the gate or post and has one installation marker positioned that is visible from a side of the gate or post when installed,
aligning the installation marker on the remote actuator to the installation marker on the guide that is coplanar with the with the aperture that is coaxial with the common axis, and
mounting the remote actuator to the gate or post.

14. A method according to claim 13 wherein the gate latch assembly includes a connector, interacting between the remote actuator and the latch, the method including measuring a distance of the opening between opposed faces of the gate or post, modifying the length of the connector to suit said distance, and fitting the connector in the opening between the remote actuator and the latch before positioning the remote actuator on the gate or post.
